(19) United States
(12) Patent Application Publication
(10) Pub. No.: US 2020/0049268 A1
(43) Pub. Date: Feb. 13, 2020

(54) Dead Weight Thief Hatch

(71) Applicant: Robert Carl Rajewski, Forestburg (CA)

(72) Inventor: Robert Carl Rajewski, Forestburg (CA)

(21) Appl. No.: 16/538,391

(22) Filed: Aug. 12, 2019

(30) Foreign Application Priority Data
Aug. 10, 2018 (CA) 3013843

(51) Int. Cl. F16K 17/194

(52) U.S. Cl. CPC F16K 17/194

(57) ABSTRACT

A thief hatch has a pressure relief valve and vacuum relief valve. Each valve may use a weighted pallet with a diaphragm that sits in operation on a seat surrounding a throat. Pressure from the interior of the tank, for the pressure relief valve, or pressure from atmosphere, for the vacuum relief valve, presses the diaphragm against the seat. If the pressure rises too much, the pallet and diaphragm will lift off the seat to relieve pressure.

### TECHNICAL FIELD

Thief hatches for tanks.

### BACKGROUND

The inventor previously invented a breather valve disclosed in U.S. Pat. No. 5,819,793. The breather valve had a valve body having a fluid passageway terminating in a valve seat, and a pressure pallet having a size commensurate with the valve seat. The pressure pallet had a sealing side oriented to face the valve seat, and was mounted for limited motion towards and away from the valve seat. A flexible diaphragm was secured to the sealing side of the pressure pallet circumferentially outside the valve seat, preferably around an outer periphery of the valve seat. The flexible diaphragm was separated from the sealing side between the first and second circumferences to create an annular cushion over the valve seat. The flexible diaphragm was fluid impervious outside of the valve seat and fluid pervious inside the valve seat. Although this valve worked well for its time, there was room for improvement.

### SUMMARY

A relief valve is provided comprising, a valve seat having a throat, a pallet constrained by guiding elements for movement towards and away from the valve seat, a diaphragm under the pallet, the diaphragm having a perimeter secured to the pallet and an interior bounded by the diaphragm and the pallet, the perimeter of the diaphragm being of greater two dimensional extent than the valve seat, the diaphragm being extended by a central extending element to form a conical or frusto-conical surface narrowing downward; and at least an opening in the diaphragm to allow fluid communication between the throat of the valve seat and the interior of the diaphragm, whereby in operation, pressure in the throat causes the diaphragm to bear against the valve seat.

A thief hatch is provided comprising a body having a portion configured for attaching the body to a tank, a valve seat supported by the body and the valve seat having a throat, a lid for the body, the lid having an underside, a pallet on the underside of the lid, the pallet being constrained by guiding elements of the lid for movement towards and away from the valve seat, a diaphragm under the pallet, the diaphragm having a perimeter secured to the pallet and an interior bounded by the diaphragm and the pallet, the perimeter of the diaphragm being of greater two dimensional extent than the valve seat, the diaphragm being extended by a central extending element to form a conical or frusto-conical surface narrowing downward, the lid being movable between a closed position in which the diaphragm contacts and rests on the valve seat and an open position in which the diaphragm is away from the valve seat, at least an opening in the diaphragm to allow fluid communication between the throat of the valve seat and the interior of the diaphragm, whereby in operation, when the lid is in the closed position, pressure in the throat causes the diaphragm to bear against the valve seat; and the lid in the open position permitting access to the throat.

In various embodiments, there may be included with the relief vale or thief hatch any one or more of the following features: the at least an opening in the diaphragm is located centrally to form a drain for liquids that precipitate out of fluids entering the interior of the diaphragm through the throat, the at least two openings comprise at least two openings, the pallet has a circular perimeter, the body is four sided in horizontal section, the lid is hinged to the body, the lid is four sided in horizontal section, a tray is disposed at least partially around the body, the guiding elements comprise a central rod received by a sleeve in the lid, the guiding elements comprise guide rods extending downward from the lid and bounding the pallet, and a vacuum relief valve is included in the body.

### BRIEF DESCRIPTION OF THE FIGURES

Embodiments will now be described with reference to the figures, in which like reference characters denote like elements, by way of example, and in which:

FIG. 1 is cross-section through an embodiment of a thief hatch; and

FIG. 2 is a perspective partially transparent view of the thief hatch of FIG. 1.

### DETAILED DESCRIPTION

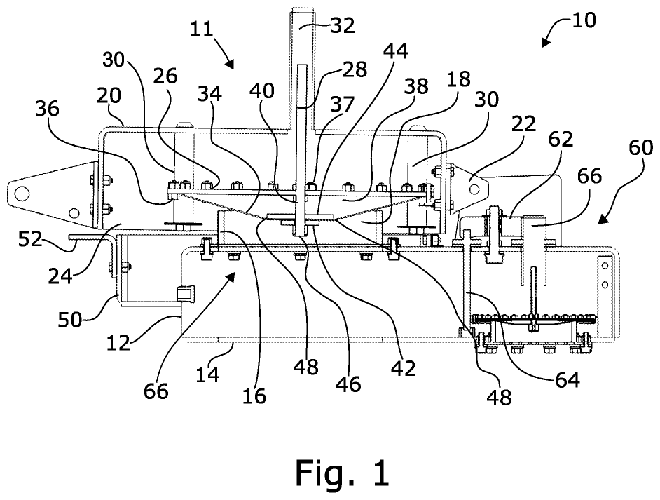

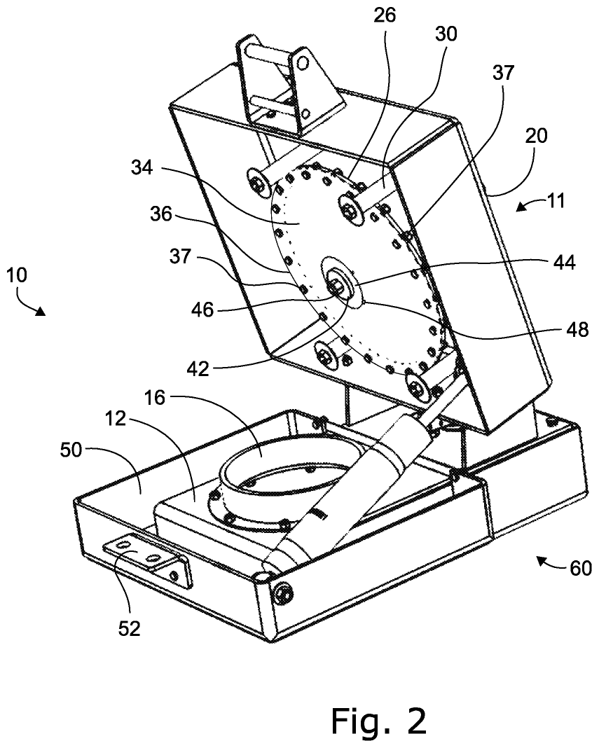

Referring to FIG. 1, there is shown a thief hatch 10. The thief hatch 10 may include a pressure relief valve 11 and a vacuum relief valve 60. The thief hatch 10 is formed of a body 12 having a portion 14 configured for attaching the body to a tank, directly or indirectly. The reference character 14 shows the general location of the portion that attaches the body to a tank. A conventional flange may be used that is bolted to a corresponding flange on the tank. If there is a valve on the tank, the body 12 may attach to the valve using for example bolts. The body 12 may be four sided in horizontal section, with rectangular corners, as shown in FIG. 2, and may be square. The body 12 may contain a pressure relief valve 11, as described in the next succeeding paragraphs and a vacuum relief valve 60 as described in the paragraphs following description of the pressure relief valve 11.

A valve seat 16 is supported by the body 12 and the valve seat has a throat 18. A lid 20 is provided for the body 12. The lid 20 may be four sided in horizontal section, with rectangular corners, as shown in FIG. 2, and may be square. The lid 20 may be hinged by hinge 22 to the body 12. The lid 20 has an underside 24. A pallet 26 is provided on the underside 24 of the lid 20. The pallet 26 is constrained by guiding elements 28, 30 that are on the underside 24 of the lid 20. The guiding elements 28 and 30 secure and guide the pallet 26 so that its movement in operation is towards and away from the valve seat 16. The guiding elements 28, 30, may take any of various forms, but in this case include a central rod 28 that is received in a sleeve, for example tube or pipe 32 that extends upward away from the lid 20. The guiding elements 30 may be rods that extend downward from the underside 24 of the lid 20 and engage and bound the sides of the pallet 26 to confine the pallet 26 to a path that takes it towards and away from the valve seat 16 when the lid 20 is closed.

A diaphragm 34 is provided under the pallet 26. The diaphragm 34 has a perimeter secured to the pallet 26 by for example a ring 36 that is bolted onto the pallet 26 by bolts 37. The perimeter may be circular. Compression of the perimeter of the diaphragm 34 by the ring 36 onto the pallet 26 seals fluids within the interior 38 bounded by the diaphragm 34 and the pallet 26. The perimeter of the diaphragm 34 is of greater two dimensional extent than the valve seat 16 so that in operation with the lid 20 in the closed position, the diaphragm 34 rests on the valve seat 16 and seals against it. Weights may be placed on the lid 20 to control the degree of downward pressure of the diaphragm 34 on the valve seat 16. The amount of pressure is selected to provide a desired pressure at which the pressure relief valve 11 opens to relieve pressure in the tank. The valve seat 16 may have an upper surface that is flat and 1 cm or more wide to provide additional back pressure on any fluids leaking through between the diaphragm 34 and valve seat 16.

The diaphragm 34 is extended by a central extending element 40 to form a conical or frusto-conical surface narrowing downward. The element 40 may be a rod extending oppositely to the rod 28 or may be an extension of the rod 28 for example. The rod may terminate in a pair of plates 42, 44 that receive the diaphragm 34 between them with a bolt 46 securing the plates 42, 44 together. The lid 20 is movable between a closed position in which the diaphragm 34 contacts and rests on the valve seat 16 (FIG. 1) and an open position in which the diaphragm 34 is away from the valve seat 16 (FIG. 2).

At least an opening 48, for example two openings 48, are provided in the diaphragm 34 to allow fluid communication between the throat 18 of the valve seat 16 and the interior 38 of the diaphragm 34, whereby in operation, when the lid 20 is in the closed position, pressure in the throat 18 from the tank causes the diaphragm 34 to bear against the valve seat 16 with a selected pressure, while the lid 20 in the open position permits access to the throat 18 and from there into the tank. The openings 48 are located inside the perimeter formed by the valve seat. The lead lines for the openings 48 point to the location of the openings in FIG. 1 and an exemplary opening 48 is indicated by a small black circle in FIG. 2

The at least an opening 48 in the diaphragm 34 may be located centrally to form a drain for liquids that precipitate out of fluids entering the interior 38 of the diaphragm 34 through the throat 18. The openings 48 may for example by 0.5 cm or ⅛ inch in diameter. The central location may be immediately adjacent the plate 48, namely at the lowest point of the diaphragm 34. A tray 50 may be provided that is disposed at least partially around the body 12 so that fluids flowing out of the body 12 collect in the tray 50. The lid 20 may be limited in downward movement by a flange 52 extending from the body 12 or other suitable surface, such as a part of or an extension from the body 12.

A vacuum relief valve 60 may also be provided in the body 12. The vacuum relief valve 60 may be designed with the same diaphragm and guided pallet configuration as described in the preceding paragraphs, except that the vacuum relief valve 60 is oriented oppositely to the pressure relief valve 11. That is, in the pressure relief configuration the conical diaphragm points towards the throat 18 and therefore the interior of the tank, and in the vacuum relief valve 60 the conical bladder 74 of the vacuum relief valve 60 points away from the interior of the tank. A nut and bolt combination 62 may hold components of the vacuum relief valve 60 in place. When the nut is released, the guide 64 may be removed, and the sleeve 66 may be removed, and then the valve 60 may be accessed or removed.

The throat 18 may have 8″ bight. The diaphragm 34 may be a diaphragm made of 1/16 Viton™ or 0.010 smooth Teflon™ for example. The diaphragm 34 should be inert to chemicals. It need not be stretchable, just a sheet, and it is better not to stretch it. Gas comes up through the openings in the diaphragm from the throat and creates a cushion. The central element flattens the diaphragm with gentle pressure into a cone with pressure in centre to remove wrinkles. The seat may be 2 inches from the outer edge of the diaphragm.

The pallet 26 sits on the rim of the seat if there no pressure in tank. When the tank is pressurized, so that there is pressure in the throat, fluid (gas, mostly) pressurizes the interior of the diaphragm, which causes the diaphragm to seat. Having a width of the rim of the seat more than 1 cm or ⅜ inch wide provides more pressure drop due to the longer passage between the diaphragm and seat.

A conical diaphragm allows the diaphragm to shift yet still find a seat without leaking. The thief hatch may be used for example on tanks at oilwell production sites or other liquid storage.

Immaterial modifications may be made to the embodiments described here without departing from what is covered by the claims.

In the claims, the word “comprising” is used in its inclusive sense and does not exclude other elements being present. The indefinite articles “a” and “an” before a claim feature do not exclude more than one of the feature being present. Each one of the individual features described here may be used in one or more embodiments and is not, by virtue only of being described here, to be construed as essential to all embodiments as defined by the claims.

1. A relief valve, comprising:
a valve seat having a throat;
a pallet constrained by guiding elements for movement towards and away from the valve seat;
a diaphragm under the pallet, the diaphragm having a perimeter secured to the pallet and an interior bounded by the diaphragm and the pallet, the perimeter of the diaphragm being of greater two dimensional extent than the valve seat;
the diaphragm being extended by a central extending element to form a conical or frusto-conical surface narrowing downward; and
at least an opening in the diaphragm to allow fluid communication between the throat of the valve seat and the interior of the diaphragm, whereby in operation, pressure in the throat causes the diaphragm to bear against the valve seat.

2. The relief valve of claim 1 configured as a thief hatch, further comprising:
a body having a portion configured for attaching the body to a tank;
the valve seat supported by the body;
a lid for the body, the lid having an underside;
the pallet being on the underside of the lid and the guiding elements extend from the underside of the lid;
the lid being movable between a closed position in which the diaphragm contacts and rests on the valve seat and an open position in which the diaphragm is away from the valve seat; whereby in operation, when the lid is in the closed position, pressure in the throat causes the diaphragm to bear against the valve seat; and
the lid in the open position permitting access to the throat.

3. The relief valve of claim 2 in which the body is four sided in horizontal section.

4. The relief valve of claim 2 in which the lid is hinged to the body.

5. The relief valve of claim 2 in which the lid is four sided in horizontal section.

6. The relief valve of claim 2 further comprising a tray disposed at least partially around the body.

7. The relief valve of claim 2 in which the guiding elements comprise a central rod received by a sleeve in the lid.

8. The relief valve of claim 2 in which the guiding elements comprise guide rods extending downward from the lid and bounding the pallet.

9. The relief valve of claim 1 in which the at least an opening in the diaphragm is located centrally to form a drain for liquids that precipitate out of fluids entering the interior of the diaphragm through the throat.

10. The relief valve of claim 1 in which the at least two openings comprise at least two openings.

11. The relief valve of claim 1 in which the pallet has a circular perimeter.

12. The relief valve of claim 1 further comprising a vacuum relief valve in combination with the relief valve.

13. The relief valve of claim 12 in which the vacuum relief valve comprises:
a further valve seat having a further throat;
a further pallet constrained by further guiding elements for movement towards and away from the further valve seat;
a further diaphragm under the further pallet, the further diaphragm having a perimeter secured to the further pallet and a further interior bounded by the further diaphragm and the further pallet, the perimeter of the further diaphragm being of greater two dimensional extent than the further valve seat;
the further diaphragm being extended by a further central extending element to form a further conical or frusto-conical surface narrowing downward; and
at least a further opening in the further diaphragm to allow fluid communication between the further throat of the further valve seat and the interior of the further diaphragm, whereby in operation, pressure in the further throat causes the further diaphragm to bear against the further valve seat.

14. A thief hatch is provided comprising a body having a portion configured for attaching the body to a tank, a valve seat supported by the body and the valve seat having a throat, a lid for the body, the lid having an underside, a pallet on the underside of the lid, the pallet being constrained by guiding elements of the lid for movement towards and away from the valve seat, a diaphragm under the pallet, the diaphragm having a perimeter secured to the pallet and an interior bounded by the diaphragm and the pallet, the perimeter of the diaphragm being of greater two dimensional extent than the valve seat, the diaphragm being extended by a central extending element to form a conical or frusto-conical surface narrowing downward, the lid being movable between a closed position in which the diaphragm contacts and rests on the valve seat and an open position in which the diaphragm is away from the valve seat, at least an opening in the diaphragm to allow fluid communication between the throat of the valve seat and the interior of the diaphragm, whereby in operation, when the lid is in the closed position, pressure in the throat causes the diaphragm to bear against the valve seat; and the lid in the open position permitting access to the throat.

15. The thief hatch of claim 14 in which the at least an opening in the diaphragm is located centrally to form a drain for liquids that precipitate out of fluids entering the interior of the diaphragm through the throat.

16. The thief hatch of claim 14 in which the at least two openings comprise at least two openings.

17. The thief hatch of claim 14, in which the pallet has a circular perimeter.

18. The thief hatch of claim 14 in which the body is four sided in horizontal section.

19. The thief hatch of claim 14 in which the lid is hinged to the body.

20. The thief hatch of claim 14 in which the lid is four sided in horizontal section.
